(19) United States
(12) Patent Application Publication
(10) Pub. No.: US 2024/0241096 A1
(43) Pub. Date: Jul. 18, 2024

(54) CARBON NUMBER DISTRIBUTION ANALYSIS OF DISTILLATION FRACTIONS

(71) Applicant: ExxonMobil Chemical Patents Inc., Baytown, TX (US)

(72) Inventors: Dennis Williams, Tomball, TX (US); Michael Player, Houston, TX (US); Kelley Bell, Corpus Christi, TX (US); Paul Hamilton, Hampshire (GB)

(21) Appl. No.: 18/561,654

(22) PCT Filed: May 12, 2022
(86) PCT No.: PCT/EP2022/062919

§ 371 Date: Nov. 16, 2023

Related U.S. Application Data
(60) Provisional application No. 63/194,481, filed on May 28, 2021.

(30) Foreign Application Priority Data
Jun. 30, 2021 (EP) 21182880.1

(51) Int. Cl. G01N 30/88; B01D 3/14; G01N 30/02

(52) U.S. Cl. CPC G01N 30/88; B01D 3/14; G01N 2030/025; G01N 2030/8854

(57) ABSTRACT

Methods and systems for analyzing the carbon number distribution of distillation fractions may utilize a fast gas chromatograph. For example, methods may comprise: distilling a hydrocarbon feed to provide a plurality of distillation fractions using a distillation column; obtaining a draw stream from one or more of the plurality of distillation fractions; and analyzing the draw stream with a fast gas chromatograph to directly determine a carbon number distribution of the draw stream, the fast gas chromatograph having a cycle time that is less than a residence time of a specified component of the draw stream within the distillation column, and the fast gas chromatograph being in-line with or in parallel with the draw stream.

### CROSS-REFERENCE TO RELATED APPLICATIONS

This application claims the priority benefit of U.S. Provisional Patent Application No. 63/194,481 filed on 28 May 2021 titled “Carbon Number Distribution Analysis of Distillation Fractions” and of EP Patent Application No. 21182880.1 filed on 30 Jun. 2021 titled “Carbon Number Distribution Analysis of Distillation Fractions”, which are incorporated herein by reference in their entirety.

### FIELD

The present disclosure relates to analyzing a carbon number distribution of distillation fractions via gas chromatography BACKGROUND

Low molecular weight hydrocarbons (e.g., having a carbon number of about C₂₄ or less) are commercially valuable compounds that may be used as starting materials in processes like polymerization or used directly for formulating lubricants. For example, linear alpha olefins (LAOs), which also may be referred to as linear alpha alkenes, linear terminal olefins, normal alpha olefins, or linear terminal alkenes, may be used, for example, as comonomers during copolymerization of ethylene, as a precursor for linear aldehydes and carboxylic acids formed through oxidation, as a precursor for linear internal olefins (LIOs) formed through double bond isomerization, and as an additive directly incorporated into drilling fluids, surfactants, lubricants, detergents, and the like, optionally after further chemical transformation thereof.

Product quality requirements for low molecular weight hydrocarbons may include limits on the carbon number of the product and the distribution of isomers within hydrocarbons having a given carbon number. The term “carbon number” refers to the number of carbon atoms in a given molecule. For example, hexane, 1-hexene, cyclohexane, and benzene all have a carbon number of 6. Low molecular weight hydrocarbon products are sometimes more valuable when said product substantially contains hydrocarbons having a single carbon number. To achieve separation based upon carbon number, low molecular weight hydrocarbon feeds may be distilled to separate the components in said feeds into fractions based on boiling point differences, which may correlate with a carbon number. Once separation has taken place, gas chromatography may be used to determine the composition of the fractions, including the carbon number distribution and the identity and concentration of particular hydrocarbon isomers within a given fraction. For higher carbon numbers (e.g., C₁₀ and greater), the time between sampling the fraction and obtaining results from the gas chromatograph can frequently be over 30 minutes. While long analysis times of these types may be sufficient for offline analyses or when monitoring a well-known distillation process, the analysis time is too long for adjusting parameters of a distillation process in real-time. Real-time knowledge of the fractions produced in a distillation process may be useful for optimizing the distillation process, such as for tailoring the carbon number distribution obtained in a given fraction. Therefore, improved methods and systems for analyzing distillation fractions in real-time is needed.

### SUMMARY

The present disclosure relates to analyzing the carbon number distribution of distillation fractions.

Disclosed herein are methods that comprise: distilling a hydrocarbon feed to provide a plurality of distillation fractions using a distillation column; obtaining a draw stream from one or more of the plurality of distillation fractions; and analyzing the draw stream with a fast gas chromatograph to directly determine a carbon number distribution of the draw stream, the fast gas chromatograph having a cycle time that is less than a residence time of a specified component of the draw stream within the distillation column, and the fast gas chromatograph being in-line with or in parallel with the draw stream.

Disclosed herein are systems that comprise: a distillation column comprising a feed inlet and a draw line, wherein the draw line is configured to provide a draw stream comprising a distillation fraction separated within the distillation column; and a fast gas chromatograph in fluid communication with the draw line, the fast gas chromatograph being configured to directly determine a carbon number distribution of the draw stream and having a cycle time that is less than a residence time of a specified component of the draw stream within the distillation column, and wherein the fast gas chromatograph is in-line with or in parallel with the draw stream.

Disclosed herein are methods that comprise: forming a product stream comprising one or more linear alpha olefins by an olefin oligomerization process; optionally hydrogenating the product stream; distilling at least a portion of the product stream to provide a plurality of distillation fractions using a distillation column; obtaining a draw stream from one or more of the plurality of distillation fractions; and analyzing the draw stream with a fast gas chromatograph to directly determine a carbon number distribution of the draw stream, the fast gas chromatograph having a cycle time that is less than a residence time of a specified component of the draw stream within the distillation column, and the fast gas chromatograph being in-line with or in parallel with the draw stream.

### BRIEF DESCRIPTION OF THE DRAWINGS

The following figures are included to illustrate certain aspects of the disclosure, and should not be viewed as exclusive configurations. The subject matter disclosed is capable of considerable modifications, alterations, combinations, and equivalents in form and function, as will occur to those skilled in the art and having the benefit of this disclosure.

FIG. 1 shows a non-limiting example method of the present disclosure for distilling a hydrocarbon feed and analyzing the carbon number distribution of a distillation fraction.

FIG. 2 shows a non-limiting example system of the present disclosure for distilling a hydrocarbon feed and analyzing the carbon number distribution of a distillation fraction.

FIG. 3A shows a gas chromatogram of a C₁₄ hydrocarbon feed obtained using a traditional gas chromatograph. FIG. 3B shows a gas chromatogram of the C₁₄ hydrocarbon feed obtained using a fast gas chromatograph.

FIG. 4A shows a gas chromatogram of a C₁₈-C₂₄ hydrocarbon feed obtained using a traditional gas chromatograph. FIG. 4B show a gas chromatogram of the C₁₈-C₂₄ hydrocarbon feed obtained using a fast gas chromatograph.

### DETAILED DESCRIPTION

The present disclosure relates to analyzing the carbon number distribution of distillation fractions obtained from a hydrocarbon feed. More specifically, the methods and systems of the present disclosure use fast gas chromatography for measuring the carbon number distribution of one or more distillation fractions. Advantageously, fast gas chromatographs may afford a cycle time from sampling to output being available for analysis of about 400 seconds or less for C₂₄ hydrocarbons. Hydrocarbons with a lower carbon number may afford even faster cycle times using a fast gas chromatograph. These cycle times are significantly faster than traditional gas chromatography, which may feature cycle times of about 30 minutes for C₁₀ compounds, such as C₁₀ hydrocarbons, and potentially cycle times of over an hour for C₂₄ compounds, such as C₂₄ hydrocarbons. Such excessive cycle times may be completely incompatible for real-time analysis of distillation fractions.

Fast gas chromatographs compatible for use in the disclosure herein may facilitate a separation based upon boiling point, rather than structure. The boiling point, in turn, may readily correlate with carbon number. Without being limited by theory, it is believed that short length columns and resistive heating to promote separation based upon boiling point may contribute to a short cycle time being realized with a fast gas chromatograph.

The systems and methods of the present disclosure may feature a fast gas chromatograph coupled with a distillation system, for example, in line with or in parallel with one or more draw streams for various distillation fractions. Coupling a fast gas chromatograph with a distillation system in this manner may allow for real-time feedback relating to the carbon number distribution of a distillation fraction to be obtained. Upon having real-time feedback of the carbon number distribution, an operator may choose (a) to change one or more operational parameters of the distillation process to optimize the composition of one or more individual distillation fractions, (b) to change one or more operational parameters of the distillation process to optimize the distillation process (e.g., for less energy consumption) while maintaining a desired composition of one or more individual distillation fractions, and/or (c) to change one or more operational parameters of an upstream process that produces a hydrocarbon feed provided to the distillation process to alter the composition of the hydrocarbon feed and, consequently, the composition of one or more individual distillation fractions.

### Definitions and Test Methods

All numerical values within the detailed description and the claims herein are modified by “about” or “approximately” with respect to the indicated value, and take into account experimental error and variations that would be expected by a person having ordinary skill in the art. Unless otherwise indicated, room temperature is about 25° C.

As used in the present disclosure and claims, the singular forms “a,” “an,” and “the” include plural forms unless the context clearly dictates otherwise.

The term “and/or” as used in a phrase such as “A and/or B” herein is intended to include “A and B,” “A or B,” “A”, and “B.”

For the purposes of the present disclosure, the new numbering scheme for groups of the Periodic Table is used. In said numbering scheme, the groups (columns) are numbered sequentially from left to right from 1 through 18, excluding the f-block elements (lanthanides and actinides).

As used herein, the term “Cₙ” refers to a hydrocarbon comprising n carbon atoms, wherein n is an integer.

As used herein, the term “Cₙ₋ₘ” refers to a hydrocarbon comprising n−m carbon atoms, wherein n and m are integers and n is greater than m.

As used herein, the term “hydrocarbon” refers to an organic compound or mixture of organic compounds that includes primarily, if not exclusively, the elements hydrogen and carbon. Optionally substituted hydrocarbons may also include other elements, such as, but not limited to, halogens, metallic elements, nitrogen, oxygen, sulfur, and any combination thereof. Unless otherwise specified, hydrocarbons may be one or more of linear, branched, cyclic, acyclic, saturated, unsaturated, aliphatic, or aromatic.

As used herein, the term “aliphatic” refers to hydrocarbons composed exclusively of hydrogen and carbon that may be linear, branched, or cyclic.

As used herein, the term “alkane” refers to aliphatic, non-cyclic hydrocarbons having only carbon-carbon single bonds.

As used herein, the term “alkene” refers to aliphatic, non-cyclic hydrocarbons having at least one carbon-carbon double bond.

As used herein, the term “cycloalkane” is synonymous with the term “cyclic hydrocarbons” and refers to aliphatic hydrocarbons containing a grouping of carbon atoms in a ring structure.

As used herein, the term “aromatic” refers to a cyclic hydrocarbon having a grouping of pi-electrons that satisfy the Hückel rule. Both mononuclear and polynuclear aromatic hydrocarbons are encompassed by these terms.

As used herein, the term “linear” refers to a grouping of carbon atoms without substantial side chain branches.

As used herein, the term “linear alpha olefin (LAO)” refers to an alkene hydrocarbon bearing a carbon-carbon double bond at a terminal (end) carbon atom of a linear main carbon chain.

As used herein, the term “light olefin” refers to an olefin having 5 carbon atoms or less, especially ethylene, propylene, and butenes (e.g., 1-butene, isobutylene, cis-2-butene, and/or trans-2-butene).

As used herein, the term “cycle time” in conjunction with a fast gas chromatograph refers to the time from (a) a sample being introduced to the fast gas chromatograph to (b) a carbon number distribution being available for analysis. Therefore, cycle time encompasses injection time, retention time, and data processing time.

As used herein, the term “residence time” in conjunction with a distillation column, a portion thereof, or associate hardware refers to an average time a molecule resides in the distillation column, the portion thereof, or the associate hardware during a distillation process. Residence time may be calculated as the total mass of liquid held in the distillation column, the portion thereof, or the associate hardware divided by the mass flow rate of a hydrocarbon feed provided to the distillation column, the portion thereof, or the associate hardware, respectively. Examples of portions of the distillation column and associated hardware may include, but are not limited to, a column overheads system (which may include the hold-up in any liquid reflux system external to the distillation column), a column bottoms system (which may include the liquid in the bottom section of the distillation column and the liquid in external reboilers and associated circuits), and the like.

### Carbon Number Distribution Methods and Systems

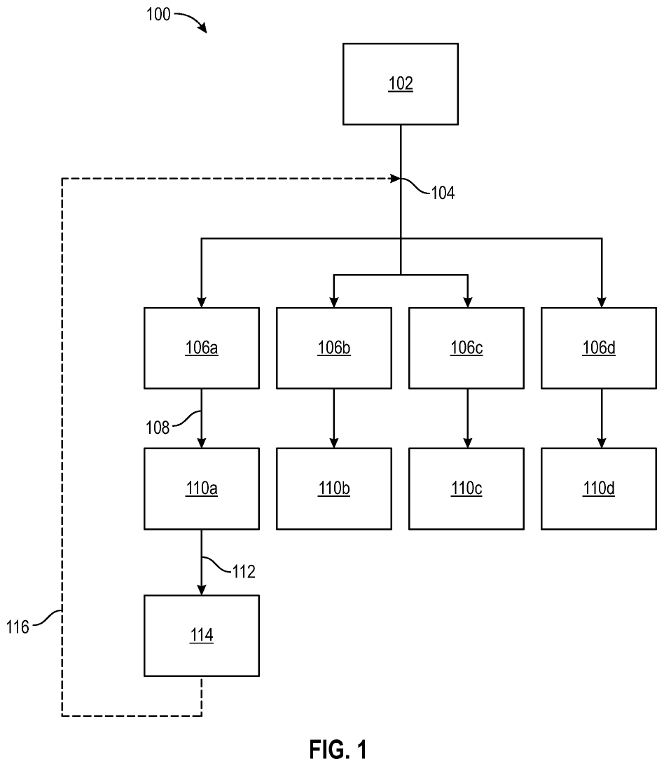

FIG. 1 illustrates a non-limiting example method 100 of the present disclosure for distilling 104 hydrocarbon feed 102 and analyzing 112 carbon number distribution 114 of distillation fraction 106a. In this example, hydrocarbon feed 102 is distilled 104 into a plurality of distillation fractions 106a, 106b, 106c, and 106d. While this example illustrates four distillation fractions 106a-d, the number of distillation fractions is not limited to four in the present disclosure. The number of distillation fractions may depend on the composition of the hydrocarbon feed, the configuration of the distillation column, and the desired composition of the distillation fractions. The number of distillation fractions may be 2 to 15 or more, or 2 to 10, or 4 to 12, or 6 to 15, or more than 15.

Draw streams 110a, 110b, 110c, and 110d are used to collect 108 at least a portion of distillation fractions 106a, 106b, 106c, and 106d. In the methods described herein, at least one of the distillation fractions (specifically distillation fraction 106a in this example) is analyzed 112 to directly determine a carbon number distribution 114 of said distillation fraction. In the illustrated example, a portion of draw stream 110a corresponding to distillation fraction 106a is conveyed to a fast gas chromatograph to directly determine carbon number distribution 114.

The fast gas chromatograph may comprise a resistively heated, micro-packed column. The fast gas chromatograph may separate various components in a sample being analyzed by boiling point and not based on specific structural features, which would be the case if an affinity column were being used, as in conventional gas chromatographic separations. The fast gas chromatograph preferably has a cycle time that is less than the residence time of a specified component of the draw stream obtained from the distillation column. The fast gas chromatograph may be capable of providing a cycle time for C₂₄ hydrocarbons of about 400 seconds or less or about 360 seconds or less. Although not configured to directly provide carbon number output, a non-limiting example fast gas chromatograph is described in U.S. Pat. No. 6,427,522, which is incorporated herein by reference.

Referring again to FIG. 1, carbon number distribution 114 corresponding to distillation fraction 106a may be presented as a chromatography spectrum (chromatogram), a table providing relative amounts of each Cₙ species in distillation fraction 106a, any other suitable output to convey the relative amount of each Cₙ species in the distillation fraction 106a, or any combination thereof. A chromatography spectrum (chromatogram) obtained from a fast gas chromatograph analyzing for carbon number may include peaks where the retention time (or a range of retention times) for each peak corresponds to a specific carbon number (Cₙ where n is the number of carbon atoms). Correlating the retention time (or range of the retention times) to a specific carbon number may be performed prior to implementation of the fast gas chromatograph in the methods and systems described herein (e.g., in a laboratory setting using known Cₙ standards to develop a range of Cₙ retention times). In one example, carbon number distribution 114 may provide process feedback 116 to the operation of distilling 104.

Accordingly, methods of the present disclosure may comprise: distilling a hydrocarbon feed to provide a plurality of distillation fractions using a distillation column; obtaining a draw stream from one or more of the plurality of distillation fractions; and analyzing the draw stream with a fast gas chromatograph to directly determine a carbon number distribution of the draw stream, the fast gas chromatograph having a cycle time that is less than a residence time of a specified component of the draw stream within the distillation column, and the fast gas chromatograph being in-line with or in parallel with the draw stream.

The carbon number distribution of the distillation fraction may be used for a variety of purposes. By way of example and not limitation, the carbon number distribution of the distillation fraction may be used to characterize the quality and/or purity of the distillation fraction.

In another example, the carbon number distribution of the distillation fraction may provide feedback for determining changes to operational parameters of the distillation process to facilitate a desired change to the carbon number distribution of the distillation fraction as the distillation process continues. Examples of operational parameters of the distillation process that may be adjusted include, but are not limited to, a temperature of a zone in the distillation column; an operating pressure of the distillation column; a draw rate for the draw stream; a feed rate of the hydrocarbon feed; a presence, an absence, or a flow rate of a reflux flow to the distillation column; a presence, an absence, or a flow rate of a return stream flow to the distillation column; a draw rate of an overheads distillation fraction; an amount of heat added to a distillation column reboiler; the like; and any combination thereof.

In yet another example, the carbon number distribution of the distillation fraction may be used to determine changes to operational parameters of an upstream process that produces the hydrocarbon feed supplied to the distillation process. For example, if the carbon number distribution reveals that an excessive amount of Cₙ₋₂ hydrocarbons are present in a fraction that should comprise predominantly Cₙ hydrocarbons, one may determine that the hydrocarbon feed is lacking in Cₙ hydrocarbons (or has over-produced Cₙ₋₂ hydrocarbons) and needs to be altered to produce greater amounts of Cₙ hydrocarbons. Optionally, the distillation process may be altered to accommodate process upsets and other factors that may provide a non-preferred hydrocarbon feed to the distillation process.

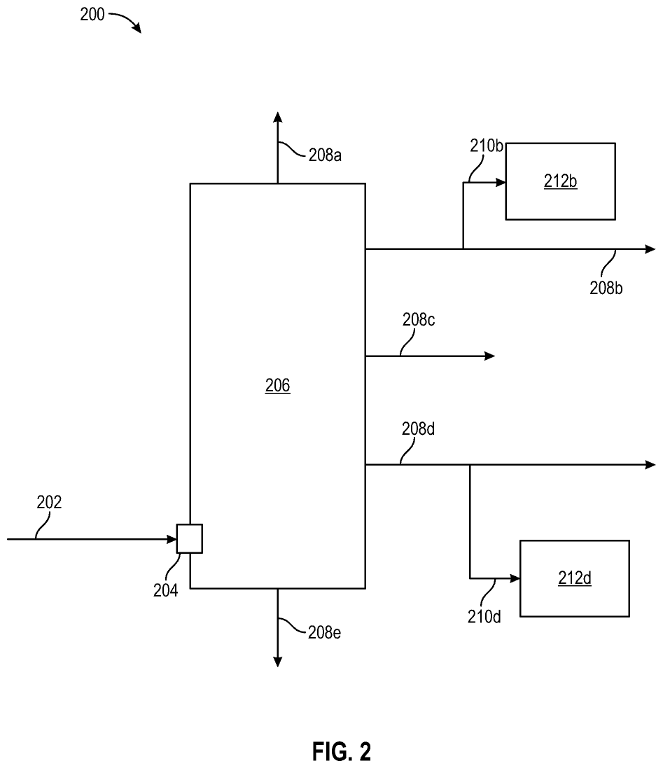

FIG. 2 illustrates a non-limiting example system 200 of the present disclosure for distilling a hydrocarbon feed and analyzing the carbon number distribution of a distillation fraction. System 200 includes distillation column 206 with a feed inlet 204 for introducing the hydrocarbon feed stream (e.g., provided by hydrocarbon feed line 202) into distillation column 206. Herein, a stream and a line are understood to have the appropriate accompanying hardware like valves, pumps, and/or gauges for conveying and/or monitoring the stream within the line and providing or conveying a hydrocarbon feed to a desired location. In the interest of simplicity, such accompanying hardware is not depicted in the figures herein.

Examples of suitable distillation column configurations include, but are not limited to, a tray distillation column, a packed distillation column (e.g., with random or structured packing), a divided wall distillation column, the like, and any hybrid thereof. The width and/or diameter of the distillation columns may be varied to accommodate a particular separation process.

Within distillation column 206 the hydrocarbon feed provided from hydrocarbon feed line 202 is separated into a plurality of distillation fractions. Distillations fractions may include any one or a combination of one or more overheads fraction, one or more side fractions, and a bottoms fraction. In FIG. 2, five distillations fractions are shown: overheads fraction 208a, bottoms fraction 208e, and three side fractions 208b, 208c and 208d. The fractions or a portion thereof are extracted from distillation column 206 using lines, illustrated in this example as three draw lines conveying side fractions 208b-208d or a portion thereof as draw streams from each of the three side fractions 208b-d, a draw stream from overheads fraction 208a, and a draw stream from bottoms fraction 208e. Again, the number of side fractions (and consequently, the number of draw streams) is not limited to three and may depend on the composition of the hydrocarbon feed, the configuration of distillation column 206, and the desired composition of various fractions that are obtained. The number of distillation fractions may be 1 to 15 or more, or 1 to 10, or 3 to 12, or 5 to 15, or more than 15.

In the methods and systems of the present disclosure, at least one of the fractions (preferably the overheads fraction and/or one or more of the side fractions) is analyzed with a fast gas chromatograph to determine the carbon number distribution of the respective fraction. In the exemplary system 200 of FIG. 2, two of the side fractions (specifically, side fractions 208b and 208d and their corresponding draw streams) are analyzed with respective fast gas chromatographs 212b and 212d. In the illustrated example, a portion of side fractions 208b and 208d are extracted via side lines 210b and 210d, respectively. Side lines 210b and 210d convey portions of the corresponding draw streams to the respective fast gas chromatographs 212b and 212d for analysis. It is to be appreciated that system 200 may analyze one draw stream or multiple draw streams, and the analysis of two draw streams provided in FIG. 2 should be considered illustrative and non-limiting. Therefore, this example illustrates fast gas chromatographs 212b and 212d in parallel with side fractions 208b and 208d and their associated side liens 210b and 210d, which provide the corresponding draw streams. Alternatively, a fast gas chromatograph may be in-line with a draw stream provided by the corresponding distillation fraction (e.g., in-line within side fraction 208b and 208d in FIG. 2). Within a system, each fast gas chromatograph may independently be in-line with or in parallel with its respective draw line. For example, in a given system, a first draw line may have a first fast gas chromatograph in-line with the draw line, and a second draw line may have a second fast gas chromatograph in parallel with the draw line. Again, it is to emphasize that one or more than one fast gas chromatograph may be present in various configurations of the systems and methods disclosed herein.

Therefore, systems of the present disclosure may comprise: a distillation column comprising a feed inlet and a draw line (which may be one or more draw lines), wherein the draw line is configured to provide a draw stream comprising a distillation fraction separated within the distillation column; and a fast gas chromatograph in fluid communication with the draw line, the fast gas chromatograph being configured to directly determine a carbon number distribution of the draw stream and having a cycle time that is less than a residence time of a specified component of the draw stream within the distillation column, and wherein the fast gas chromatograph is in-line with or in parallel with the draw stream. In one example, the specified component within the draw stream may be a hydrocarbon having a target carbon number.

Systems of the present disclosure may further include a hydrocarbon processing operation in fluid communication with the distillation column, where a hydrocarbon feed may be provided from the hydrocarbon processing operation. Examples of hydrocarbon processing operations include, but are not limited to, olefin oligomerization processes, hydroformylation processes, hydrogenation processes, and the like, particularly light olefin oligomerization processes.

Therefore, more specific systems of the present disclosure may comprise: an olefin oligomerization unit (or system), a hydroformylation unit (or system), a hydrogenation unit (or system), or a similar unit (or system) capable of producing a hydrocarbon feed that is in fluid communication with a distillation column, the distillation column comprising a feed inlet capable of receiving the hydrocarbon feed from said unit (or system) and a draw line (which may be one or more draw lines), wherein the draw line is configured to provide a draw stream comprising a distillation fraction separated within the distillation column; and a fast gas chromatograph in fluid communication with the draw line, the fast gas chromatograph being configured to directly determine a carbon number distribution of the draw stream and having a cycle time that is less than a residence time of a specified component of the draw stream within the distillation column, and wherein the fast gas chromatograph is in-line with or in parallel with the draw stream.

Various aspects of the systems and methods described herein may utilize computer systems, such as to process data received within the fast gas chromatograph to determine a carbon number and/or to provide process feedback to a distillation column or a hydrocarbon processing operation. Such systems and methods may include a non-transitory computer readable medium containing instructions that, when implemented, cause one or more processors to carry out the methods described herein.

“Computer-readable medium” or “non-transitory, computer-readable medium,” as used herein, refers to any non-transitory storage and/or transmission medium that participates in providing instructions to a processor for execution. Such a medium may include, but is not limited to, non-volatile media and volatile media. Non-volatile media includes, for example, NVRAM, or magnetic or optical disks. Volatile media includes dynamic memory, such as main memory. Common forms of computer-readable media include, for example, a floppy disk, a flexible disk, a hard disk, an array of hard disks, a magnetic tape, or any other magnetic medium, magneto-optical medium, a CD-ROM, a holographic medium, any other optical medium, a RAM, a PROM, and EPROM, a FLASH-EPROM, a solid state medium like a memory card, any other memory chip or cartridge, or any other tangible medium from which a computer can read data or instructions. When the computer-readable media is configured as a database, it is to be understood that the database may be any type of database, such as relational, hierarchical, object-oriented, and/or the like. Accordingly, exemplary embodiments of the present systems and methods may be considered to include a tangible storage medium or tangible distribution medium and prior art-recognized equivalents and successor media, in which the software implementations embodying the present techniques are stored.

The methods described herein can be performed using computing devices or processor-based devices that include a processor; a memory coupled to the processor; and instructions provided to the memory, wherein the instructions are executable by the processor to perform the methods described herein. The instructions can be a portion of code on a non-transitory computer readable medium. Any suitable processor-based device may be utilized for implementing all or a portion of embodiments of the present techniques, including without limitation personal computers, networks of personal computers, laptop computers, computer workstations, mobile devices, multi-processor servers or workstations with (or without) shared memory, high performance computers, and the like. Moreover, embodiments may be implemented on application specific integrated circuits (ASICs) or very large scale integrated (VLSI) circuits.

For example, the systems described herein may include a controller capable of receiving data from the fast gas chromatograph and sending instructions regarding operational parameters to the distillation column and associated hardware. The instructions may, for example, relate to operational parameters of the distillation process and, more specifically, to (a) changes to one or more operational parameters of the distillation process to change and/or optimize the composition of one or more individual distillation fractions and/or (b) changes to one or more of the distillation process to change and/or optimize the distillation process (e.g., for less energy consumption) while maintaining a desired composition of one or more individual distillation fractions. Illustrative operational parameters are provided above.

In another example, the systems described herein may include a controller capable of receiving data from the fast gas chromatograph and sending instructions regarding operational parameters to an upstream system and associated hardware from which a hydrocarbon feed is produced. The instructions may, for example, relate to operational parameters of the upstream process and, more specifically, to change to one or more operational parameters of the upstream process that produces the hydrocarbon feed to optimize the composition of the hydrocarbon feed and, consequently, the composition of one or more individual distillation fractions.

The foregoing controllers may comprise a processor; a memory coupled to the processor; and instructions provided to the memory, wherein the instructions are executable by the processor to perform said methods.

### Hydrocarbon Feeds and Resultant Draw Streams

The systems and methods described herein may be applicable to a variety of hydrocarbon feeds. The hydrocarbon feed may be a product of an olefin oligomerization process, a hydroformylation process, a hydrogenation process, or a similar process (particularly a light olefin oligomerization process).

With respect to an olefin oligomerization process, such hydrocarbon feeds may be characterized as containing linear alpha olefins (LAOs). Optionally, at least a portion of a hydrocarbon feed containing LAOs may be hydrogenated to form the corresponding alkanes. LAOs may be synthesized by several different processes starting from low molecular weight feedstock materials. The primary route for synthesizing LAOs is via ethylene oligomerization, of which there are several synthetic variants that may be mediated using different Ziegler-type catalysts. Depending on the particular Ziegler-type catalyst and the synthetic conditions, ethylene oligomerization reactions may form a distributed range of homologous LAOs having an even number of carbon atoms (e.g., C₂ₙH₂ₙ, where n is a positive integer greater than or equal to 2), or a predominant LAO (e.g., 1-butene, 1-hexene, 1-octene, or 1-decene) may be produced in much higher amounts than the other LAOs. When a distributed range of homologous LAOs is formed, the LAO product distribution may follow a Shulz-Flory distribution, with the distribution being arranged about a central molecular weight. Such LAO syntheses are referred to herein as being “non-specific” LAO syntheses. Such processes are also commonly referred to as full-range or wide-range LAO synthesis processes. LAO syntheses affording a predominant LAO (e.g., about 70 wt % or more or about 90 wt % or more of the LAOs in the product stream) may also form up to about 10 wt % of other minor product LAOs and additional byproducts. Such LAO syntheses are referred to herein as being “specific” LAO syntheses, and they may sometimes be referred to in the art as “on-purpose” LAO syntheses.

Commercially available homogeneous catalyst systems and processes available for light olefin oligomerization include, but are not limited to, DIMERSOL-E™ (available from Axens), DIMERSOL-X™ (available from Axens), DIMERSOL-G™ (available from Axens), Shell higher olefins process, Axens ALPHABUTOL® process, Axens ALPHAHEXOLT™ process, and SABIC ALPHA-SABLIN process. Commercially available heterogeneous catalysts available for light olefin oligomerization include, but are not limited to, Clariant POLYMAX® catalyst (available from Clariant), LC 1252 (available from Axens), and LC 1255 (available from Axens).

If reduction has taken place, a hydrocarbon feed received from an LAO synthesis may comprise alkanes or alkanes in combination with alkenes. Such hydrocarbon feeds (LAO hydrocarbon feeds) may comprise alkanes and/or alkenes having even carbon numbers of C₄ to C₂₄. LAO hydrocarbon feeds may additionally comprise 0 wt % up to about 5 wt % (or 0 wt % up to about 3 wt %) of a hydrocarbon species having a carbon number of C₂₄ or greater. LAO hydrocarbon feeds may comprise one or more hydrocarbons having a carbon number of C₂₄ or less, or C₂₀ or less, or C₁₆ or less, or C₁₄ or less, or C₄ to C₂₄, or C₄ to C₂₀, or C₄ to C₁₆, or C₄ to C₁₄. LAO hydrocarbon feeds may consist of one or more hydrocarbons having a carbon number of C₂₄ or less, or C₂₀ or less, or C₁₆ or less, or C₁₄ or less, or C₄ to C₂₄, or C₄ to C₂₀, or C₄ to C₁₆, or C₄ to C₁₄.

Draw streams resulting from distillation of an LAO hydrocarbon feed may comprise an alkane, an alkene, or any combination thereof. The alkane and/or alkene may be obtained from (a) an ethylene oligomerization process or (b) hydrogenation of a reaction product obtained from an ethylene oligomerization process, including those described in more detail above.

At least one draw stream resulting from distillation of an LAO hydrocarbon feed may comprise one or more hydrocarbons having a carbon number of C₂₄ or less. When analyzing an LAO hydrocarbon feed, a peak obtained from the fast gas chromatograph with a retention time within a predetermined range of retention times is classified as comprising Cₙ hydrocarbons, a peak obtained from the fast gas chromatograph with a retention time below the range of retention times for Cₙ is classified as comprising Cₙ₋₂ hydrocarbons, and a peak obtained from the fast gas chromatograph with a retention time above the range of retention times for Cₙ is classified as comprising Cₙ₊₂ hydrocarbons. The area under each peak and/or the intensity of each peak may be correlated to a specific concentration of each carbon number detected. Alternatively, the area under each peak and/or the intensity of each peak may be correlated to a relative concentration of each carbon number detected. Therefore, the fast gas chromatograph may be used for directly determining the carbon number distribution of a distillation fraction corresponding to the draw stream being sampled.

The range of retention times for Cₙ hydrocarbons may be obtained using assaying known hydrocarbon samples having a specified carbon number (Cₙ), where n is the number of carbon atoms. Draw streams having an unknown composition may then be measured in comparison to the range of retention times measured for the known hydrocarbon samples.

For example, a draw stream may comprise (or consist of) one or more Cₙ₋₂hydrocarbons, one or more Cₙ hydrocarbons, and one or more Cₙ₊₂ hydrocarbons, where n is 6-22, or 6-12, or 8-20, or 10-20). In another example, a draw stream may comprise (or consist of) one or more Cₙ₋₂ hydrocarbons, one or more Cₙ hydrocarbons, one or more Cₙ₊₂ hydrocarbons, and one or more Cₙ₊₄ hydrocarbons, where n is 6-20, or 6-12, or 8-18, or 10-20. Within the Cₙ₋₂, Cₙ, Cₙ₊₂, Cₙ₊₄, etc. hydrocarbons, there may be multiple structural isomers that elute within a specified boiling point range and are categorized as having a specified carbon number. The number of structural isomers may differ depending on the carbon number being analyzed; higher carbon numbers afford a larger number of structural isomers. In yet another example, a draw stream may comprise (or consist of) one or more Cₙ₋₂ hydrocarbons and one or more Cₙ hydrocarbons, where n is 6-24, or 6-12, or 8-20, or 10-24.

At least one draw stream resulting from distillation of an LAO hydrocarbon feed may have a density of about 600 kg/m³ to about 880 kg/m³, or about 600 kg/m³ to about 750 kg/m³, or about 680 kg/m³ to about 800 kg/m³, or about 750 kg/m³ to about 880 kg/m³.

In another example, the hydrocarbon feed may comprise at least about 90 wt % of (a) cyclic hydrocarbons, (b) aromatic hydrocarbons, or (c) a combination of cyclic hydrocarbons and aromatic hydrocarbons. Such cyclic and/or aromatic hydrocarbon feeds may comprise 0 wt % to about 5 wt % (up to about 5 wt %) or 0 wt % to about 3 wt % of a hydrocarbon having a carbon number of C₂₄ or greater. Cyclic and/or aromatic hydrocarbon feeds may comprise one or more cyclic and/or aromatic hydrocarbons having a carbon number of C₂₄ or less, or C₂₀ or less, or C₁₆ or less, or C₁₄ or less, or C₄ to C₂₄, or C₄ to C₂₀, or C₄ to C₁₆, or C₄ to C₁₄. Cyclic and/or aromatic hydrocarbon feeds may consist of one or more cyclic and/or aromatic hydrocarbons having a carbon number of C₂₄ or less, or C₂₀ or less, or C₁₆ or less, or C₁₄ or less, or C₄ to C₂₄, or C₄ to C₂₀, or C₄ to C₁₆, or C₄ to C₁₄.

At least one draw stream obtained from distillation of a hydrocarbon feed comprising cyclic and/or aromatic hydrocarbons may comprise one or more cyclic and/or aromatic hydrocarbons having a carbon number of C₂₄ or less.

In yet another example, the hydrocarbon feed may comprise at least about 90 wt % alcohols. Such alcohol hydrocarbon feeds may comprise 0 wt % to about 5 wt % (up to about 5 w %) or 0 wt % to about 3 wt % of a hydrocarbon having a carbon number of C₂₄ or greater. Alcohol hydrocarbon feeds may comprise one or more alcohol hydrocarbons having a carbon number of C₂₄ or less, or C₂₀ or less, or C₁₆ or less, or C₁₄ or less, or C₄ to C₂₄, or C₄ to C₂₀, or C₄ to C₁₆, or C₄ to C₁₄. Alcohol hydrocarbon feeds may consist of one or more alcohol hydrocarbons having a carbon number of C₂₄ or less, or C₂₀ or less, or C₁₆ or less, or C₁₄ or less, or C₄ to C₂₄, or C₄ to C₂₀, or C₄ to C₁₆, or C₄ to C₁₄.

At least one draw stream resulting from distillation of a hydrocarbon feed comprising one or more alcohols may comprise one or more alcohols having a carbon number of C₂₄ or less.

### Example Embodiments

A first nonlimiting example is a method comprising: distilling a hydrocarbon feed to provide a plurality of distillation fractions using a distillation column; obtaining a draw stream from one or more of the plurality of distillation fractions; and analyzing the draw stream with a fast gas chromatograph to directly determine a carbon number distribution of the draw stream, the fast gas chromatograph having a cycle time that is less than a residence time of a specified component of the draw stream within the distillation column, and the fast gas chromatograph being in-line with or in parallel with the draw stream. The first nonlimiting example may further include one or more of Element 1: wherein the cycle time for C₂₄ hydrocarbons is about 400 seconds or less; Element 2: the method further comprising: adjusting one or more operational parameters of the distillation column based on the carbon number distribution of the draw stream; Element 3: Element 2 and wherein the one or more operational parameters comprises at least one of: a temperature of a zone in the distillation column; an operating pressure of the distillation column; a draw rate of the draw stream; a feed rate of the hydrocarbon feed; a presence, an absence, or a flow rate of a reflux flow to the distillation column; a presence, an absence, or a flow rate of a return stream flow to the distillation column; a draw rate of an overheads distillation fraction; and an amount of heat added to a distillation column reboiler; Element 4: wherein the fast gas chromatograph comprises a resistively heated, micro-packed column; Element 5: the method further comprising: determining a range of retention times for one or more known hydrocarbon samples having a specified carbon number (Cₙ), wherein n is a number of carbon atoms; Element 6: Element 5 and herein a peak obtained from the fast gas chromatograph having a retention time within the range of retention times is classified as comprising Cₙ hydrocarbons, a peak obtained from the fast gas chromatograph with a retention time below the range of retention times for Cₙ is classified as comprising Cₙ₋₂ hydrocarbons, and a peak obtained from the fast gas chromatograph with a retention time above the range of retention times for Cₙ is classified as comprising Cₙ₊₂ hydrocarbons; Element 7: wherein a hydrocarbon product within the draw stream has a density of about 600 kg/m³ to about 880 kg/m³; Element 8: wherein the draw stream comprises an alkane, an alkene, or any combination thereof; Element 9: Element 8 and wherein the alkane and/or the alkene are obtained from (a) an ethylene oligomerization process or (b) hydrogenation of a reaction product obtained from an ethylene oligomerization process; Element 10: wherein the draw stream comprises one or more hydrocarbons having a carbon number of C₂₄ or less; Element 11: wherein the hydrocarbon feed comprises up to about 5 wt % hydrocarbons having a carbon number of C₂₄ or greater; and Element 12: wherein the hydrocarbon feed is a product of an olefin oligomerization process. Examples of combinations include, but are not limited to, Element 1 in combination with one or more of Elements 2-12; Element 2 (optionally in combination with Element 3) in combination with one or more of Elements 4-12; Element 4 in combination with one or more of Elements 5-12; Element 5 (optionally in combination with Element 6) in combination with one or more of Elements 7-12; Element 6 in combination with one or more of Elements 7-12; Element 7 in combination with one or more of Elements 8-12; Element 8 (optionally in combination with Element 9) in combination with one or more of Elements 10-12; and two or more of Elements 10-12 in combination.

A second nonlimiting example is a system comprising: a distillation column comprising a feed inlet and a draw line, wherein the draw line is configured to provide a draw stream comprising a distillation fraction separated within the distillation column; and a fast gas chromatograph in fluid communication with the draw line, the fast gas chromatograph being configured to directly determine a carbon number distribution of the draw stream and having a cycle time that is less than a residence time of a specified component of the draw stream within the distillation column, and wherein the fast gas chromatograph is in-line with or in parallel with the draw stream. The second nonlimiting example may further include one or more of Element 13: wherein a cycle time for C₂₄ hydrocarbons from the fast gas chromatograph is about 400 seconds or less; Element 14: wherein the distillation column is a tray distillation column, a packed distillation column, a divided wall distillation column, or any combination thereof; Element 15: wherein the fast gas chromatograph comprises a resistively heated, micro-packed column; Element 16: wherein the distillation column is in fluid communication with a hydrocarbon processing operation; Element 17: Element 16 and wherein the hydrocarbon processing operation comprises an olefin oligomerization process; Element 18: the method further comprising: a controller capable of receiving data from the fast gas chromatograph and sending instructions regarding one or more operational parameters to the distillation column and associated hardware. Examples of combinations include, but are not limited to, Element 13 in combination with one or more of Elements 14-18; Element 14 in combination with one or more of Elements 15-18; Element 15 in combination with one or more of Elements 16-18; and Element 16 (optionally in combination with Element 17) in combination Element 18.

A third nonlimiting example is a method comprising: forming a product stream comprising one or more linear alpha olefins by an olefin oligomerization process; optionally hydrogenating the product stream; distilling at least a portion of the product stream to provide a plurality of distillation fractions using a distillation column; obtaining a draw stream from one or more of the plurality of distillation fractions; and analyzing the draw stream with a fast gas chromatograph to directly determine a carbon number distribution of the draw stream, the fast gas chromatograph having a cycle time that is less than a residence time of a specified component of the draw stream within the distillation column, and the fast gas chromatograph being in-line with or in parallel with the draw stream. The third nonlimiting example may further include one or more of: Element 19: wherein the olefin oligomerization process is an ethylene oligomerization process; Element 20: the method further comprising: adjusting one or more operational parameters of the olefin oligomerization process based on the carbon number distribution of the draw stream; Element 21: wherein the product stream comprises one or more alkanes and/or alkenes having even carbon numbers from C₄ to C₂₄; Element 22: wherein the product stream comprises about 70% or greater by mass of an alkane and/or an alkene having an even carbon number from C₄ to C₂₄; Element 23: the method further comprising: determining a range of retention times for one or more known hydrocarbon samples having a specified carbon number (C₁), wherein n is a number of carbon atoms; and Element 24: Element 23 and wherein a peak obtained from the fast gas chromatograph having a retention time within the range of retention times is classified as comprising Cₙ hydrocarbons, a peak obtained from the fast gas chromatograph with a retention time below the range of retention times for Cₙ is classified as comprising Cₙ₋₂ hydrocarbons, and a peak obtained from the fast gas chromatograph with a retention time above the range of retention times for Cₙ is classified as comprising Cₙ₊₂ hydrocarbons. Examples of combinations include, but are not limited to, Element 19 in combination with one or more of Elements 20-24; Element 20 in combination with one or more of Elements 21-24; Element 21 in combination with one or more of Elements 22-24; and Element 22 in combination with Element 23 (optionally in combination with Element 24).

To facilitate a better understanding of the embodiments of the present disclosure, the following examples of preferred or representative embodiments are given. In no way should the following examples be read to limit, or to define, the scope of the present disclosure.

### Examples

Fast gas chromatograms were obtained using an ABB Automation Gas Chromatograph (Model PGC5009), modified to provide output based on carbon number. The unmodified gas chromatographs are described in further detail in U.S. Pat. No. 6,427,522, which is incorporated herein by reference. Detection was based upon flame ionization.

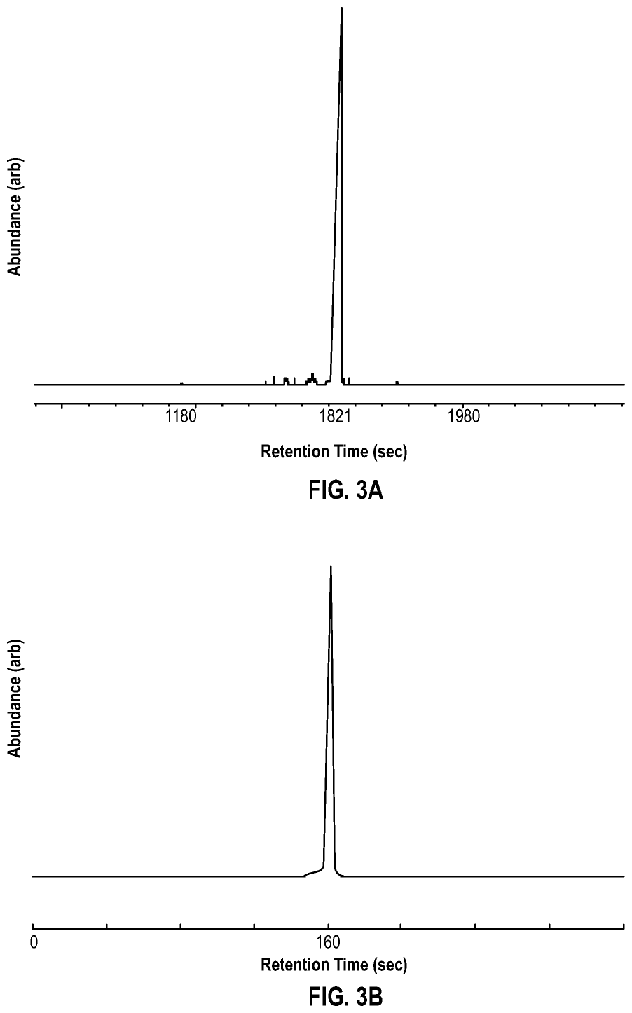

FIG. 3A shows a gas chromatogram of a C₁₄ hydrocarbon feed obtained using a traditional gas chromatograph. The chromatogram appears to show a predominant product and several minor products resolved above baseline. FIG. 3B shows a gas chromatogram of the C₁₄ hydrocarbon feed obtained using a fast gas chromatograph. In the case of a fast gas chromatograph, the C₁₄ hydrocarbons have a similar boiling point and elute as substantially a single peak. The predominant C₁₄ product elutes at about 1825 seconds (about 30 minutes) using the traditional gas chromatograph (FIG. 3A) and at about 160 seconds (about two and a half minutes) using the fast gas chromatograph (FIG. 3B). Thus, the cycle time using the fast gas chromatograph is short enough to make strategic decisions about a hydrocarbon processing operation and/or a distillation operation. Accordingly, this example illustrates the speed of the fast gas chromatograph for directly determining the carbon number of a hydrocarbon sample, which when integrated with distillation methods and distillation systems allow for a real-time carbon number analysis of distillation fraction.

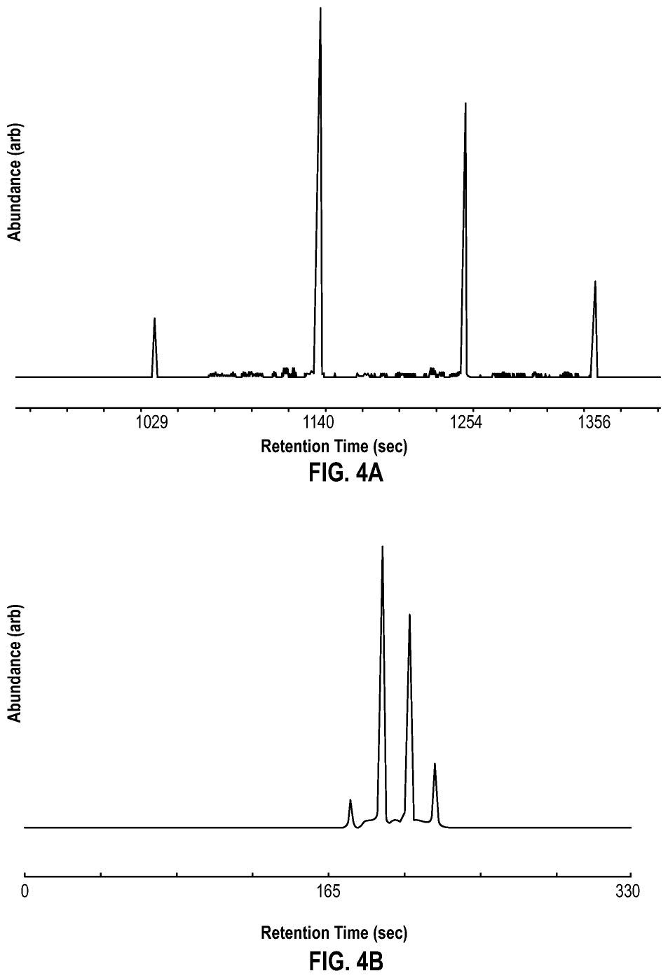

FIG. 4A shows a gas chromatogram of a C₁₈-C₂₄ hydrocarbon feed obtained using a traditional gas chromatograph. Again, the chromatogram appears to show predominant peaks and minor products resolved above baseline around the elution times of the two most intense peaks. FIG. 4B show a gas chromatogram of the C₁₈-C₂₄ hydrocarbon feed obtained using a fast gas chromatograph. The C₁₈-C₂₄ product finishes elution by about 1400 seconds (about 23 minutes) in the traditional gas chromatograph and by about 250 seconds (about 4 minutes) in the fast gas chromatograph. The fast gas chromatograph plot illustrates that the peaks for each of the carbon numbers C₁₈, C₂₀, C₂₂, and C₂₄ are clearly distinguishable, which makes fast gas chromatography suitable for analyzing carbon number distribution in real-time. This example also illustrates the speed of the fast gas chromatograph for directly determining the carbon number of a hydrocarbon sample, which when integrated with distillation methods and distillation systems allows for a real-time carbon number distribution analysis of distillation fraction.

Unless otherwise indicated, all numbers expressing quantities of ingredients, properties such as molecular weight, reaction conditions, and so forth used in the present specification and associated claims are to be understood as being modified in all instances by the term “about.” Accordingly, unless indicated to the contrary, the numerical parameters set forth in the following specification and attached claims are approximations that may vary depending upon the desired properties sought to be obtained by the incarnations of the present inventions. At the very least, and not as an attempt to limit the application of the doctrine of equivalents to the scope of the claim, each numerical parameter should at least be construed in light of the number of reported significant digits and by applying ordinary rounding techniques.

One or more illustrative incarnations incorporating one or more invention elements are presented herein. Not all features of a physical implementation are described or shown in this application for the sake of clarity. It is understood that in the development of a physical embodiment incorporating one or more elements of the present invention, numerous implementation-specific decisions must be made to achieve the developer's goals, such as compliance with system-related, business-related, government-related and other constraints, which vary by implementation and from time to time. While a developer's efforts might be time-consuming, such efforts would be, nevertheless, a routine undertaking for those of ordinary skill in the art and having benefit of this disclosure.

While compositions and methods are described herein in terms of “comprising” various components or steps, the compositions and methods can also “consist essentially of” or “consist of” the various components and steps.

Therefore, the present invention is well adapted to attain the ends and advantages mentioned as well as those that are inherent therein. The particular examples and configurations disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative examples disclosed above may be altered, combined, or modified and all such variations are considered within the scope and spirit of the present invention. The invention illustratively disclosed herein suitably may be practiced in the absence of any element that is not specifically disclosed herein and/or any optional element disclosed herein. While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces.

1. A method comprising:
distilling a hydrocarbon feed to provide a plurality of distillation fractions using a distillation column;
obtaining a draw stream from one or more of the plurality of distillation fractions; and
analyzing the draw stream with a fast gas chromatograph to directly determine a carbon number distribution of the draw stream, the fast gas chromatograph having a cycle time that is less than a residence time of a specified component of the draw stream within the distillation column, and the fast gas chromatograph being in-line with or in parallel with the draw stream.

2. The method of claim 1, wherein the cycle time for C₂₄ hydrocarbons is about 400 seconds or less.

3. The method of claim 1, further comprising:
adjusting one or more operational parameters of the distillation column based on the carbon number distribution of the draw stream.

4. The method of claim 3, wherein the one or more operational parameters comprises at least one of: a temperature of a zone in the distillation column; an operating pressure of the distillation column; a draw rate of the draw stream; a feed rate of the hydrocarbon feed; a presence, an absence, or a flow rate of a reflux flow to the distillation column; a presence, an absence, or a flow rate of a return stream flow to the distillation column; a draw rate of an overheads distillation fraction; and an amount of heat added to a distillation column reboiler.

5. The method of claim 1, wherein the fast gas chromatograph comprises a resistively heated, micro-packed column.

6. The method of claim 1, further comprising:
determining a range of retention times for one or more known hydrocarbon samples having a specified carbon number (Cₙ), wherein n is a number of carbon atoms.

7. The method of claim 6, wherein a peak obtained from the fast gas chromatograph having a retention time within the range of retention times is classified as comprising Cₙ hydrocarbons, a peak obtained from the fast gas chromatograph with a retention time below the range of retention times for Cₙ is classified as comprising Cₙ₋₂ hydrocarbons, and a peak obtained from the fast gas chromatograph with a retention time above the range of retention times for Cₙ is classified as comprising Cₙ₊₂ hydrocarbons.

8. The method of claim 1, wherein a hydrocarbon product within the draw stream has a density of about 600 kg/m³ to about 880 kg/m³.

9. The method of claim 1, wherein the draw stream comprises an alkane, an alkene, or any combination thereof.

10. The method of claim 9, wherein the alkane and/or the alkene are obtained from (a) an ethylene oligomerization process or (b) hydrogenation of a reaction product obtained from an ethylene oligomerization process.

11. The method of claim 1, wherein the draw stream comprises one or more hydrocarbons having a carbon number of C₂₄ or less.

12. The method of claim 1, wherein the hydrocarbon feed comprises up to about 5 wt % hydrocarbons having a carbon number of C₂₄ or greater.

13. The method of claim 1, wherein the hydrocarbon feed is a product of an olefin oligomerization process.

14. A system comprising:
a distillation column comprising a feed inlet and a draw line, wherein the draw line is configured to provide a draw stream comprising a distillation fraction separated within the distillation column; and
a fast gas chromatograph in fluid communication with the draw line, the fast gas chromatograph being configured to directly determine a carbon number distribution of the draw stream and having a cycle time that is less than a residence time of a specified component of the draw stream within the distillation column, and wherein the fast gas chromatograph is in-line with or in parallel with the draw stream.

15. The system of claim 14, wherein a cycle time for C₂₄ hydrocarbons from the fast gas chromatograph is about 400 seconds or less.

16. The system of claim 14, wherein the distillation column is a tray distillation column, a packed distillation column, a divided wall distillation column, or any combination thereof.

17. The system of claim 14, wherein the fast gas chromatograph comprises a resistively heated, micro-packed column.

18. The system of claim 14, wherein the distillation column is in fluid communication with a hydrocarbon processing operation.

19. The system of claim 14, further comprising:
a controller capable of receiving data from the fast gas chromatograph and sending instructions regarding one or more operational parameters to the distillation column and associated hardware.

20. A method comprising:
forming a product stream comprising one or more linear alpha olefins by an olefin oligomerization process;
optionally hydrogenating the product stream;
distilling at least a portion of the product stream to provide a plurality of distillation fractions using a distillation column;
obtaining a draw stream from one or more of the plurality of distillation fractions; and
analyzing the draw stream with a fast gas chromatograph to directly determine a carbon number distribution of the draw stream, the fast gas chromatograph having a cycle time that is less than a residence time of a specified component of the draw stream within the distillation column, and the fast gas chromatograph being in-line with or in parallel with the draw stream.
